(19) United States
(12) Patent Application Publication
(10) Pub. No.: US 2015/0114547 A1
(43) Pub. Date: Apr. 30, 2015

(54) Plasma Crucible Sealing

(71) Applicant: Ceravision Limited, Milton Keynes (GB)

(72) Inventors: Andrew Simon Neate, Mentmore (GB); Barry Preston, Melton Mowbray (GB)

(21) Appl. No.: 14/400,072

(22) PCT Filed: May 3, 2013
(86) PCT No.: PCT/GB2013/051174

§ 371 Date: Nov. 10, 2014

(30) Foreign Application Priority Data
May 10, 2012 (GB) 1208369.7

(51) Int. Cl. H01J 9/395; H01J 9/40

(52) U.S. Cl. CPC H01J 9/395; H01J 9/40
USPC 156/145

(57) ABSTRACT

A plasma crucible (92) has a through bore (93) and two tubes (981,982) butt sealed on to the end faces (901,902) of the crucible. One (981) of the tubes is closed prior to the filling of the crucible. The tube is tipped off and worked in a glass lathe to form it to have a flat end (983). After evacuation, dosing and gas fill, the end (983) is heated to drive off impurities in the dose, with its active constituent condensing within the bore (93). Then, the other tube (902) is tipped off in the similar manner.

The present invention relates to plasma crucible sealing and a sealed plasma crucible.

In our PCT/GB2008/003829, we have described and claimed a light source to be powered by microwave energy, the source having:
a solid plasma crucible of material which is lucent for exit of light therefrom, the plasma crucible having a sealed void in the plasma crucible,
a Faraday cage surrounding the plasma crucible, the cage being at least partially light transmitting for light exit from the plasma crucible, whilst being microwave enclosing,
a fill in the void of material excitable by microwave energy to form a light emitting plasma therein, and
an antenna arranged within the plasma crucible for transmitting plasma-inducing microwave energy to the fill, the antenna having:
   a connection extending outside the plasma crucible for coupling to a source of microwave energy;
      the arrangement being such that light from a plasma in the void can pass through the plasma crucible and radiate from it via the cage.

In that application, we gave the following definitions: “lucent” means that the material, of which the item described as lucent, is transparent or translucent;

“plasma crucible” means a closed body [for] enclosing a plasma, the latter being in the void when the void's fill is excited by microwave energy from the antenna. In this application we continue to use the definition, with the proviso that it is in the context of sealing a crucible, which does not contain a plasma during sealing. Accordingly, as used herein, the definition includes the word “for”.

We have come to refer to the technology of the above application as Light Emitting Resonator or LER technology.

In this application, we define:

“filled plasma crucible” to mean a lucent plasma crucible having sealed in its void an excitable, light emitting fill.

A filled plasma crucible as such may have an antenna fixedly sealed within the crucible, possibly in the void, or a re-entrant in the crucible, into which an antenna is inserted for use of the crucible.

In our International Application No. WO 2010/094938, (Our '938 Application) there is described and claimed a method of sealing a filled plasma crucible consisting in the steps of:
providing a plasma crucible of lucent material having an open void, the void having a mouth;
providing a tube of extending away from the mouth of the crucible, the tube being hermetically sealed to the crucible;
inserting excitable material into the void via the tube;
evacuating the void via the tube;
introducing an inert gas into the void via the tube; and
sealing the void, enclosing the excitable material and the inert gas, by sealing the tube at or close to the mouth.

In certain embodiments of Our '938 Application:
the void is provided with a stop for a plug at the mouth of the void and
a plug is positioned in the mouth against the stop via the tube, the plug and the mouth being complementarily shaped for location of the plug for its sealing in the mouth and provided with clearance and/or local shaping to allow gas flow from and to the void.
   In another alternative, the plug can be sealed against a flat face of the crucible.

In other embodiments, the plug is not used, with the tube being positioned on and fused onto a face of the crucible. Alternatively, the tube can be positioned in and fused into a counterbore in the face of the crucible at the mouth of the void.

In some uses of the filled plasma crucible, it will be supported via the tube which will remain extending from the crucible. In other uses, the tube will be removed close to the seal and the crucible supported from its body.

We have developed our technology further to include that of our International application No PCT/GB2011/001744 (Our '744 Application), which is not yet published, but which describes and claims:

A Lucent Waveguide Electromagnetic Wave Plasma Light Source comprising:
a fabrication of solid-dielectric, lucent material, the fabrication providing at least:
   a closed void containing electromagnetic wave excitable plasma material;
a Faraday cage:
   enclosing the fabrication,
   being at least partially lucent, for light emission from it and
   delimiting a waveguide, the waveguide having:
      a waveguide space, the fabrication occupying at least part of the waveguide space; and
at least partially inductive coupling means for introducing plasma exciting electromagnetic waves into the waveguide at a position at least substantially surrounded by solid dielectric material;
   whereby on introduction of electromagnetic waves of a determined frequency a plasma is established in the void and light is emitted via the Faraday cage;
the arrangement being such that there is:
   a first region of the waveguide space extending between opposite sides of the Faraday cage at this region, this first region:
      accommodating the inductive coupling means and
      having a relatively high volume average dielectric constant and
a second region of the waveguide space extending between opposite sides of the Faraday cage at this region, this second region:
   having a relatively low volume average dielectric constant.

We coined the term Lucent Waveguide Electromagnetic Wave Plasma Light Source in Our '744 Application, specifically to encompass the invention of that application, which we refer to herein as our LEX invention and our LER invention. We abbreviate the term to LUWPL.

In Our '744 Application we defined a LUWPL to be:

A microwave plasma light source having:
a fabrication of solid-dielectric, lucent material, having;
   a closed void containing electro-magnetic wave, normally microwave, excitable material; and
a Faraday cage:
   delimiting a waveguide,
   being at least partially lucent, and normally at least partially transparent, for light emission from it,
   normally having a non-lucent closure and
   enclosing the fabrication;
provision for introducing plasma exciting electro-magnetic waves, normally microwaves, into the waveguide;

the arrangement being such that on introduction of electro-magnetic waves, normally microwaves, of a determined frequency a plasma is established in the void and light is emitted via the Faraday cage.

It is known that, where the excitable material is a metal halide and that it is liable to be contaminated with impurities such as hydrogen iodide. Oxides of carbon, hydrocarbons and water can be present. These impurities can be driven off by heating the material. Such heating is liable to cause the material itself to sublime and re-condense in another part of the system being sealed, the system normally including a bulb. If the material is inserted into the bulb initially, it is liable to sublime out of the bulb and require to be separately heated to cause it to move back into the bulb.

The object of the present invention is to provide an improved method of sealing a LUWPL in which the need for a separate step of heating sublimed excitable material to cause it to move back is avoided.

According to the invention there is provided: a method of sealing a filled LUWPL suitable for use with a surrounding Faraday cage for establishment of a microwave excited plasma in the filled void, the method consisting in the steps of:
providing an unsealed LUWPL of lucent material with a void open at one end only, the void having an open end at one face of a fabrication of the unsealed LUWPL and extending towards another face thereof;
providing a sealing tube of lucent material fusible to the fabrication, the tube being of a smaller cross-section than the LUWPL;
   the sealing tube being aligned with the void and extending away from the one face at a mouth of the open void and
   the sealing tube being hermetically sealed directly to the fabrication of the unsealed LUWPL in communication with the void leaving the one face extant radially beyond the tube after its sealing on;
inserting excitable material into the void via the sealing tube;
evacuating the void via the sealing tube, with the tube oriented such that the excitable material drops to the other face end of the void;
heating the lucent material surrounding the other face end of the void to drive off volatile impurity from the excitable material, the impurity being evacuated;
allowing the excitable material to condense at least substantially within the void;
introducing an inert gas into the void via the tube; and
sealing of the void, enclosing the excitable material and the inert gas, by sealing the sealing tube at or close to the mouth.

Preferably, the sealing tube is:
a tube fused on the fabrication of the unsealed LUWPL or
an integral part of the fabrication, and preferably
   a continuation from the one face of a tube in the fabrication providing the void.

Normally:
the step of sealing of the void comprises tipping off the sealing tube flush with or preferably beyond the one face to provide a cool spot, possibly with the inclusion of a sealing plug with the sealing tube and
the step of heating the lucent material surrounding the other face end of the void to drive off volatile impurity includes heating the closure and/or the other face adjacent the closure with the excitable material resting on the closure inside the void.

Preferably, the step of sealing of the void is performed by heating of the tube at or preferably adjacent the front or tubular wall, allowing differential pressure, normally atmospheric pressure, or more accurately the difference between ambient pressure and internal pressure, to collapse the tube and seal itself, preferably adjacent the said wall to leave a stub of tube extending from the wall with the void within the tube extending through the wall.

Where the LUWPL is an LER, the step of providing the unsealed LUWPL of lucent material, preferably polycrystalline ceramic or quartz, can consists in:
fabricating a plasma crucible by moulding and sintering, with the void moulded in from one face thereof.

Alternatively, it can consist in:
forming from a block of quartz, including machining the void in it from one face thereof preferably with ultrasonic cleaning and flame polishing of the machined void, and
closing the fabrication by a closure of lucent material at the other face, preferably by:
   fusing another tube onto or into the other face and tipping off the tube.

In either case:
the sealing tube can be positioned on and fused onto the one face of the lucent, plasma crucible or
the sealing tube can be positioned in and fused into a counterbore in the one face of the lucent, plasma crucible at the mouth of the void.

Preferably the method also includes the step of
separating a portion of the or each tube remote from the lucent, plasma crucible at its seal.

Where the LUWPL is an LEX, the step of providing the unsealed LUWPL of lucent material can consist in:
fabricating an unsealed LEX fabrication of solid-dielectric lucent material, preferably polycrystalline ceramic or quartz, and embodying at least an enclosure of the void to contain when sealed electromagnetic wave excitable plasma material and a walled cavity around the void, the fabricating step including:
providing the sealing tube as a tube from which to form the void,
sealing its one end to form one end of the void,
passing it through a wall of the cavity and fusing it thereto.

It is envisaged that the walls of the cavity may be unitary, as in a bulb. In this case the assembly and fusing step will be redundant. However, normally the fabricating step will include assembling and fusing together further cavity wall portions.

The further cavity wall portions can include a flat front wall through which the tube is passed, a tubular portion extending back from the front wall and a back wall spaced from the front wall, with the tubular wall preferably extending back from the back wall to provide a skirt to surround a solid dielectric block in use of the fabrication and wherein:
the step of passing the said through a wall of the cavity and fusing it thereto includes passing it through the front wall towards the back wall, either with a gap between the sealed, one end of the void or with the sealed, one end being fused into the back wall and
the step of heating the lucent material surrounding the other face end of the void to drive off volatile impurity from the excitable material is carried out by applying heat, preferably by gas torch, to the back wall, within the skirt where provided.

Alternatively, the further cavity wall portions can include a front, preferably hemi-spherical wall through which the tube is passed, a tubular portion extending back from the front wall and a back wall spaced from the front wall, with the tubular wall preferably extending back from the back wall to provide a skirt to surround a solid dielectric block in use of the fabrication and wherein:
the step of passing the said through a wall of the cavity and fusing it thereto includes passing it through the tubular wall towards an opposite side thereof, either with a gap between the sealed, one end of the void or with the sealed, one end being fused into the tubular wall at the opposite side and
the step of heating the lucent material surrounding the other face end of the void to drive off volatile impurity from the excitable material is carried out by applying heat, preferably by gas torch, to the tubular wall at the opposite side.

Again, the further cavity wall portions can include a flat or hemi-spherical front wall through which the tube is passed, a tubular portion extending back from the front wall and a back wall spaced from the front wall, with the tubular wall preferably extending back from the back wall to provide a skirt to surround a solid dielectric block in use of the fabrication and wherein:
the step of heating the lucent material surrounding the other face end of the void to drive off volatile impurity from the excitable material is carried out by directing a high temperature gas flow into the cavity and against the tube forming the void at its sealed end via a piercing in the tubular wall.

To help understanding of the invention, a number of specific embodiments thereof will now be described by way of example and with reference to the accompanying drawings, in which:

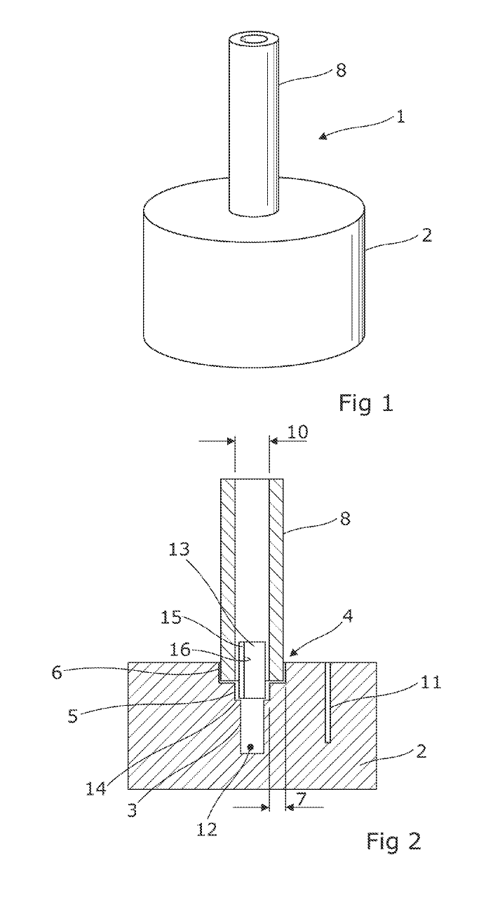

FIG. 1 is a perspective view of an LER crucible and tube prepared for sealing in accordance with the invention;

FIG. 2 is a cross-sectional side view of the crucible and tube of FIG. 1;

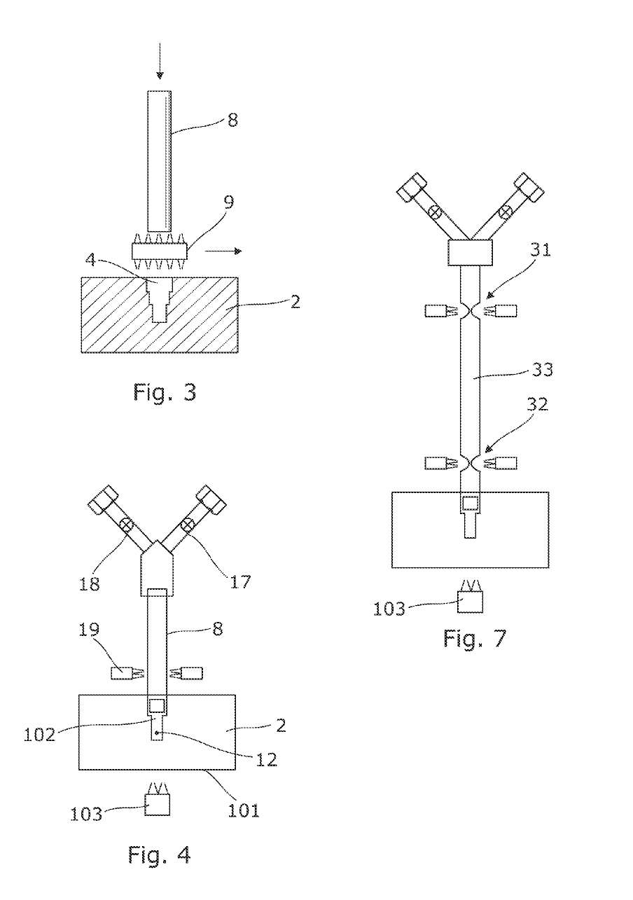

FIG. 3 is a side view of the crucible and tube being heated for sealing together;

FIG. 4 is a similar view of the tube being heated for sealing of the crucible;

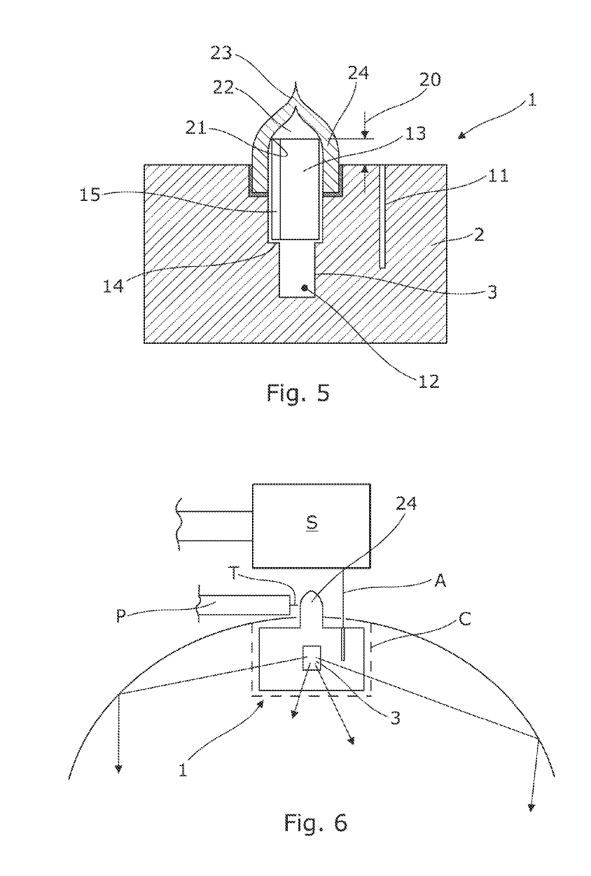

FIG. 5 is a cross-sectional side view similar to FIG. 2 of the filled plasma crucible sealed in accordance with the invention;

FIG. 6 is a schematic view of the filled plasma crucible of FIG. 1 in use;

FIG. 7 is a view similar to FIG. 4 showing an alternative manner of heating the tube for sealing of the crucible;

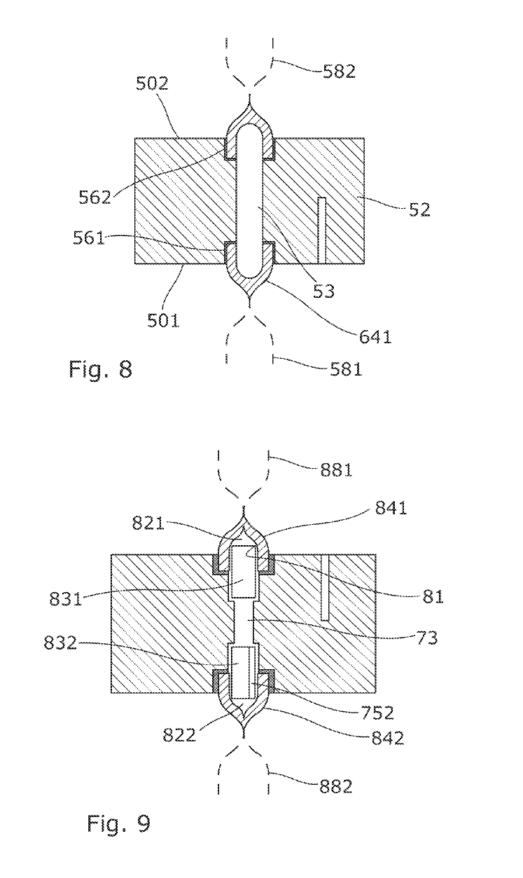

FIG. 8 is a view similar to FIG. 5 of a variant of the filled plasma crucible sealed in accordance with the invention;

FIG. 9 is a view similar to FIG. 5 of another variant of the filled plasma crucible sealed in accordance with the invention;

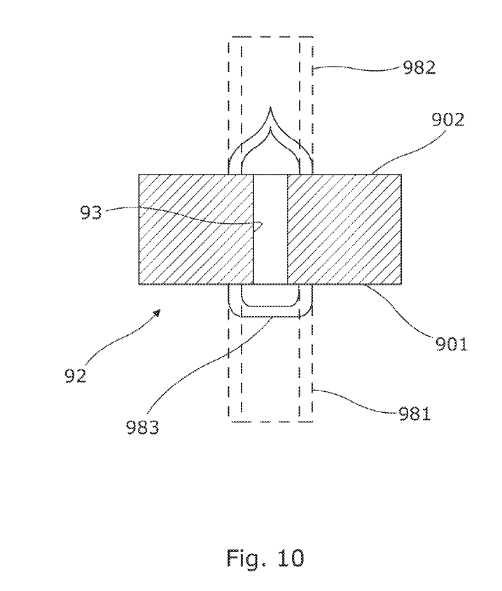

FIG. 10 is a view similar to FIG. 5 of yet another variant of the filled plasma crucible sealed in accordance with the invention;

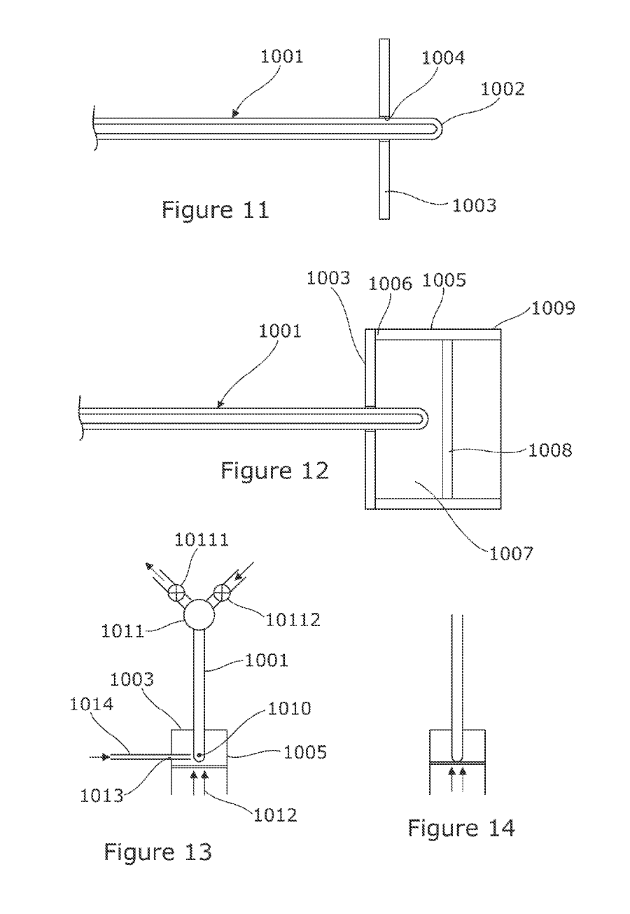

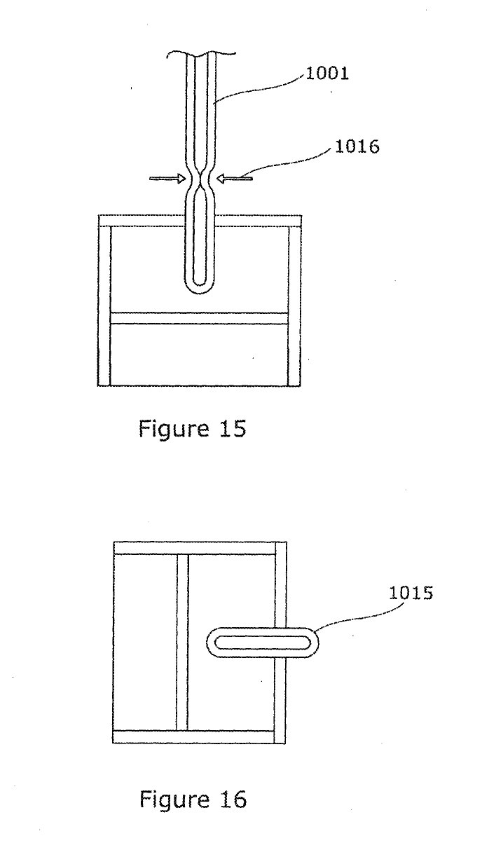

FIGS. 11 to 16 are diagrammatic views of the steps in sealing of an LEX fabrication in accordance with the invention.

Referring to FIGS. 1 to 6, a quartz crucible 1 for an LER to be filled with noble gas and dosed with excitable plasma material is formed as a thick disc/short circular cylinder 2 defining the effective dimensions of the finished crucible and having a central void 3 opening on one end of the crucible at a mouth 4. The mouth is in the form of a pair of counterbores 5,6, the inner one 5 being deeper than the outer one 6, which provides an appreciable increment 7 in radius. A tube 8 having a wall thickness nominally the same as the increment is attached to the cylinder by heating via a double-sided burner 9. The heating and the insertion is controlled to ensure that a hermetic seal is created between the cylinder and the tube, with minimum obstruction of the full internal bore 10 of the tube continuing past the tube into the inner counterbore 5. From the same end of the crucible as the tube extends, an antenna re-entrant 11 extends into the cylinder at a radius equal to one quarter of the latter's diameter.

A pellet 12 of excitable material is dropped into the void via that the tube, followed by a circular cylindrical plug 13. This is of a clearance diameter in the bore 10 and comes to rest on the step 14 between the counter bore 5 and the void 3. To provide for initial gas communication from the void past the plug, this has a shallow groove 15 along its length, which continues in its inner face 16 beyond the radial extent of the step.

The distal end of the tube is connected to vacuum pump (not shown as such) via a Y fitting having a first valve and union 17 for connection to the pump and a second valve and union 18 for connection to a source of noble gas at a controlled, sub-atmospheric pressure (the source as such also not shown). The void is evacuated via the valve 17, which is closed after evacuation.

During evacuation enough heat is applied to the face 101 of the crucible opposite from that which has the counterbores 5,6, as shown in FIG. 4, to cause the pellet to sublime. In subliming any hydrogen iodide and/or other impurities in the pellet is gasified and evacuated. The crucible being of quartz, which is a poor conductor of heat in comparison with other ceramic materials such as alumina, does not heat to an even temperature during the time that the pellet takes to sublime. The result is the metal halide material of the pellet condenses as condensate 102 on the wall of bore 3 closer to the plug 13 than the original position of the pellet. Continued heat from the face 101 will move the condensate further from the face 101. However, where as preferred, the heat is applied with a hand-held burner 103, the heating can be stopped as soon as the pellet is seen to have sublimed, the quartz being transparent.

The void is then charged with noble gas via the valve 18, which again is closed after charging. The gas is able to reach the void via the groove 15.

The final stage in formation of a filled plasma crucible is heating of the tube via a burner 19. The heating is continued until the quartz material of the tube softens and the excess of atmospheric pressure over the internal pressure of the noble gas causes the tube to collapse on itself. The plug seated on the step 14 extends slightly into the tube 8 and past the external face of the end of the crucible, as is shown by the dimension 20. The heating is made just beyond this dimension, whereby as the tube collapses, it shrinks onto the outer end corner 21 of the plug. Thus the void is double sealed in that any vestigial space 22 at the end of the plug is sealed from the void at the corner 21 and a complete closure of the tube is achieved at the “tip off” 23 of the tube, where the distal end piece of the tube is drawn away from the crucible after collapse of the tube.

Should any of the excitable material have condensed on the plug and be caused to resublime, with no heat now being applied to the face 101, the material condenses again closer to the face 101.

FIG. 6 shows this filled plasma crucible installed for use with a Faraday cage C surrounding it and an antenna A extending into the antenna re-entrant 11 to introduce microwaves from a source S of them. For starting a plasma discharge in the void, a starter probe P is arranged with its tip T adjacent the vestigial stub 24 of the tube between the tip off 23 and the back end of the crucible.

In the variant shown in FIG. 7, the tube is longer and is initially sealed and tipped off at a position 31 remote from the crucible as such, to captivate the noble gas and the excitable material in the device, in like manner to that of our earlier bulb sealing patent No. EP 1,831,916. The device can now be manipulated freely from the Y fitting. The tube is then sealed and tipped off at 32 as described above at the plug. This arrangement allows ready manipulation of the intermediate length 33 of tube to be discarded, in turn allowing for uniformly repetitive production. Should any of the excitable material have condensed in the tube 33, the heating to tipping off temperature will cause the material to resublime back at the crucible end of the tube.

A further variant is shown in FIG. 8, in which the void 53 is initially formed as a through bore from end face 501 to end face 502 of the crucible cylinder 52. The bore is formed with single counterbores 561,562 at both faces. Prior to sealing, the void is ultrasonically cleaned and then flame polished, to remove any drilling debris that might otherwise interfere with the plasma discharge in use, to remove crack propagation sites and to improve transparency. After polishing, a tube 581,582 is sealed into each bore. The one tube 581 is sealed and tipped off to leave a vestigial stub 641.

The excitable material is added as in the first embodiment. During evacuation, the vestigial stub 641 is heated to gasify the impurities. The stub is of less thermal mass than the lower portion of the crucible above the face 101. Thus the pellet can be caused to sublime with application of less heat and with more certainty the material will all condense in the void 53.

After gasification, the heating of the stub and the evacuation are both ceased and noble gas is introduced as described above.

This variant can provide a cold spot at the outer vestigial stub of the crucible in use, that is at the end from which light collected for use. This end is expected to run cooler than the other end, which will have its vestigial stub in a casing, not shown, and the details of which are likely to vary with use of the crucible.

Another variant is shown in FIG. 9. In this, the two ends of the void 73 are both closed by plugs 831,832 and the vestiges 841,842 of tubes 881,882. This arrangement has advantage over that of FIG. 8, in allowing protection of the crucible/tube and tube tip-off seals from direct contact with the gas in the void, which supports the plasma centrally of the void. It should be noted that this variant has two spaces 821,822 on the ends of the plugs remote from the void. Whilst the tube will be sealed with a view to a hermetic seal forming at the corners 81 of the plugs, it can be expected that this seal may not be hermetic, allowing excitable material to condense into the spaces. Therefore, for maximum performance, the excitable material is preferably provided in sufficient excess as to be able to fill these spaces fully and indeed the groove 752 in the plug via which the noble gas is introduced, the other plug is un-grooved, since no gas is introduced via it.

The invention is not intended to be restricted to the details of the above described embodiments. For instance, the stepped counter bore and circular cylindrical plug can be replaced by a complementarily tapered bore and plug. Further it is expected to be possible to seal the tube to crucible without the counter-bore 6 by performing this sealing operation in a lathe.

Such a plasma crucible 92 is shown in FIG. 10. It has a through bore 93 and two tubes 981,982 initially butt sealed on to the end faces 901,902 of the crucible. One 981 of the tubes is closed prior to the filling of the crucible. Since there is no differential pressure across the tube as it is tipped off, it can be worked in a glass lathe to form it to have a flat end 983. This allows the plasma void to be of well defined dimension at this side. It is this end 983, which is lowermost after introduction of the pellet of excitable material, on which the pellet comes to rest and which is heated for gasification of the impurities. Due to tolerances and availability of standard tube, it is anticipated that internal diameter of the tubes 901,902 is likely to slightly exceed that of the bore 93. After evacuation, dosing, gasification and gas fill, the other tube 902 is tipped off in the similar manner, although less working to close dimensions is advisable. In use the flat end 983 is likely to be outermost, possibly covered by a Faraday cage (not shown) and exposed to the ambient environment. The other tipped off end is likely to covered by a supporting structure (also not shown). In addition to a flat end 983, we have successfully tested a hemispherical end.

In a further alternative, in contrast to a through-bored crucible, which can be treated as mentioned above for removal of micro-cracks, or indeed a section of thick wall tube, it is possible for applications where product life is not a primary concern, to bore the void from one side of a piece of quartz. Again it can be envisaged that the crucible might be formed of sintered material. In such instances, a single tube only can be butt sealed around the mouth of the void and sealed in the manner described.

Typically in use of a quartz crucible operating at 2.4 GHz, the crucible can be circularly cylindrical with a diameter of 49 mm and a thickness of 21 mm. The diameter of the void is not thought to be critical and can vary between 1mm for low power and 10 mm for high power. We have used a sealing tube having wall thicknesses between 1 mm and 3 mm. We have also tested crucibles with tipped off tubes up to 30 mm in length from the face of the crucible. We prefer the internal length of the tipped off tube back to the face to be between zero and 10 mm. The preferred distance is 5 mm. Provision of such a length of tube is envisaged to be useful in holding the crucible in subsequent processing and/or use thereof.

Turning on to FIGS. 11 to 16, the fabrication and sealing of an LEX LUWPL will now be described. A drawn quartz tube 1001 has its “inner” end 1002 sealed. It is passed through a polished quartz disc 1003 with a central bore 1004, at which the tube is fused to the disc. A circular cylindrical sleeve 1005 of quartz is fused to the disc, with the latter closing its end 1006. The sleeve forms a tubular wall of a cavity 1007. A second, back-wall disc 1008 is fused within the sleeve parallel to the first, front-wall disc 1003, enclosing the cavity and the sealed end of the tube. It extends on as a skirt 1009. The fabrication in its unsealed state is arranged with the tube substantially upright and a pellet 1010 of excitable material is dropped into the tube, to rest on the sealed end.

A vacuum pump is attached via a two-way valve 1011 and the tube is evacuated. To drive off impurities from the pellet, it is caused to sublime and condense on a portion of the tube still within the cavity. The impurities are vaporised and drawn off by the vacuum pump. Heat for this can be applied in a number of ways. As shown in FIG. 13, a torch flame 1012 can be played on the back-wall disc 1008 heating the sealed end radiantly and convectively. Alternatively, since at this stage the cavity is un-evacuated having a side wall aperture 1013, a hollow tube 1014 can be inserted through the aperture and hot gas played on the sealed end. In a variant shown in the FIG. 14, the tube 1001 has its inner end sealed to the inner wall 1008. In this instance, flame torch heating will lead to quicker sublimation, there being no air gap between the wall and the tube. It is anticipated that this variant may result in differential thermal expansion of the void enclosure and the outer tube, in turn resulting in cracking of the fabrication. This disadvantage may outweigh the advantage of ease of heating for impurity expulsion.

After the sublimation and impurity drive off step, the evacuation branch 10111 of the two-way valve is closed and the noble gas charging branch 10112 of the valve is opened. Charging is to less than atmospheric pressure. A further torch application 1016 to the tube where it projects from the front wall causes the tube to collapse here and seal. The tube is severed. The nearly complete fabrication is placed in a glass lathe and the sealing tip 1015 is worked to regular shape. The final step is evacuation of the cavity within the walls and charging of it with inert gas such as nitrogen to a pressure less than atmospheric. The aperture 1013 is closed.

The sequence of fabrication can vary. For instance the sealing of the tube 1001, including the driving out of the impurities, can be carried out with only the disc 1003 fused onto the tube or with the disc 1003 and the sleeve 1005 fused on. This latter sequence allows access to the closed end of the tube for its heating and driving off of the impurities.

It is envisaged that the walls of the cavity may be unitary, as in a bulb. In this case the assembly and fusing step will be redundant. However, normally the fabrication will include two or three wall portions assembled and fused together. Typically these will include a flat front wall through which the tube is passed, a tubular portion extending back from the front wall and a back wall spaced from the front wall, with the tubular wall normally extending back from the back wall to provide a skirt to surround a solid dielectric block in use of the fabrication.

Alternatively, the void can be oriented differently, with the tube extending diametrically of the tubular wall. Again the flat front wall and the tubular wall can be combined in a semi-spherical wall, with the tube extending axially or transversely of the fabrication.

Where the tube does not extend from the front wall as far as the back wall, it will be sealed at its inner end, typically by tipping of, with the tipped-off, inner end spaced from the back or inner wall, although this has the differential heating issue noted above. Alternatively the inner end can abut and be sealed to the back wall. Similarly, where the void extends diametrically of the tubular wall it may be sealed to the wall at both ends, but it will preferably be sealed to it at one end only.

Where the tube extends from the front wall to the back wall, or across the fabrication, being sealed to the tubular wall at diametrically opposite ends, the heating the lucent material to drive off volatile impurity can be achieved by the application of heat, as from a gas torch, to the wall to which the inner end of the tube is sealed or to the portion of the tubular wall to which the sealed end is fused.

Alternatively where the sealed end of the tube is spaced from the inner or tubular wall, the inner end can still be heated for driving off impurity by application of heat to the wall from which the sealed end is spaced. Alternatively, the tubular wall can be pierced and a tube for directing a high temperature gas flow into the cavity and against the tube at its sealed end. Again, as noted above, the assembly sequence can be modified allowing heating for impurity drive off prior to finishing of the fabrication assembly which is what renders this heating awkward.

Final sealing of the tube is convenient performed by heating of the tube at or preferably adjacent the front or tubular wall, allowing differential pressure to collapse the tube and seal itself. This is will normally be adjacent the wall to leave a stub of tube extending from the wall with the void within the tube extending through the wall. This provides a cool spot for condensation of the excitable material after normal use of the LEX.

The invention is not intended to be restricted to the details of the above described embodiments, variants and modifications. For instance, the void enclosure can be oriented differently from that shown in FIG. 16. It could be arranged transversely of the outer tube. To avoid differential expansion difficulties the enclosure would be secured in one side of the outer tube only.

1-12. (canceled)

13. A method of sealing a filled LUWPL suitable for use with a surrounding Faraday cage for establishment of a microwave excited plasma in the filled void, the method consisting in the steps of:
providing an unsealed LUWPL of lucent material with a void open at one end only, the void having an open end at one face of a fabrication of the unsealed LUWPL and extending towards another face thereof;
providing a sealing tube of lucent material fusible to the fabrication, the tube being of a smaller cross-section than the fabrication,
the sealing tube being aligned with the void and extending away from the one face at a mouth of the open void;
fusing the sealing tube,
the sealing tube being hermetically sealed directly to the fabrication of the unsealed LUWPL in communication with the void leaving the one face extant radially beyond the tube after its sealing on;
inserting excitable material into the void via the sealing tube;
evacuating the void via the sealing tube, with the tube oriented such that the excitable material drops to the other face end of the void;
heating the lucent material surrounding the other face end of the void to drive off volatile impurity from the excitable material, the impurity being evacuated;
allowing the excitable material to condense at least substantially within the void;
introducing an inert gas into the void via the tube; and
sealing of the void, enclosing the excitable material and the inert gas, by sealing the sealing tube at or close to the mouth.

14. A method according to claim 13, wherein the sealing tube is:
a tube fused on the fabrication of the unsealed LUWPL or
an integral part of the fabrication, and preferably
a continuation from the one face of a tube in the fabrication providing the void.

15. A method according to claim 13, wherein the step of sealing of the void consists of tipping off the sealing tube flush with or preferably beyond the one face to provide a cool spot, possibly with the inclusion of a sealing plug with the sealing tube.

16. A method according to claim 13, wherein the step of providing the unsealed LUWPL of lucent material, preferably polycrystalline ceramic or quartz, consists in:
fabricating a plasma crucible by moulding and sintering, with the void moulded in from one face thereof.

17. A method according claim 13, wherein the step of providing the unsealed LUWPL of lucent material consists in:
forming from a block of quartz, including machining the void in it from one face thereof preferably with ultrasonic cleaning and flame polishing of the machined void, and preferably
closing the fabrication by a closure of lucent material at the other face, preferably by:
fusing another tube onto or into the other face and tipping off the tube.

18. A method according to claim 13, wherein the step of heating the lucent material surrounding the other face end of the void to drive off volatile impurity includes heating the closure and/or the other face adjacent the closure with the excitable material resting on the closure inside the void.

19. A method according to claim 17, wherein:
the sealing tube is positioned on and fused onto the one face of the lucent, plasma crucible or
the sealing tube is positioned in and fused into a counterbore in the one face of the lucent, plasma crucible at the mouth of the void.

20. A method according to claim 18, wherein:
the sealing tube is positioned on and fused onto the one face of the lucent, plasma crucible or
the sealing tube is positioned in and fused into a counterbore in the one face of the lucent, plasma crucible at the mouth of the void.

21. A method according to claim 13, wherein the step of providing the unsealed LUWPL of lucent material consists in:
fabricating an unsealed LEX fabrication of solid-dielectric lucent material, preferably polycrystalline ceramic or quartz, and embodying at least an enclosure of the void to contain when sealed electromagnetic wave excitable plasma material and a walled cavity around the void, the fabricating step including:
providing the sealing tube as a tube from which to form the void,
sealing its one end to form one end of the void,
passing it through a wall of the cavity and fusing it thereto, and preferably
assembling and fusing together further cavity wall portions where provided.

22. A method according to claim 21, wherein the further cavity wall portions include a flat front wall through which the tube is passed, a tubular portion extending back from the front wall and a back wall spaced from the front wall, with the tubular wall preferably extending back from the back wall to provide a skirt to surround a solid dielectric block in use of the fabrication and wherein:
the step of passing the said through a wall of the cavity and fusing it thereto includes passing it through the front wall towards the back wall, either with a gap between the sealed, one end of the void or with the sealed, one end being fused into the back wall and
the step of heating the lucent material surrounding the other face end of the void to drive off volatile impurity from the excitable material is carried out by applying heat, preferably by gas torch, to the back wall, within the skirt where provided.

23. A method according to claim 21, wherein the further cavity wall portions include a front, preferably hemi-spherical wall through which the tube is passed, a tubular portion extending back from the front wall and a back wall spaced from the front wall, with the tubular wall preferably extending back from the back wall to provide a skirt to surround a solid dielectric block in use of the fabrication and wherein:
the step of passing the said through a wall of the cavity and fusing it thereto includes passing it through the tubular wall towards an opposite side thereof, either with a gap between the sealed, one end of the void or with the sealed, one end being fused into the tubular wall at the opposite side and
the step of heating the lucent material surrounding the other face end of the void to drive off volatile impurity from the excitable material is carried out by applying heat, preferably by gas torch, to the tubular wall at the opposite side.

24. A method according to claim 21, wherein the further cavity wall portions include a flat or hemi-spherical front wall through which the tube is passed, a tubular portion extending back from the front wall and a back wall spaced from the front wall, with the tubular wall preferably extending back from the back wall to provide a skirt to surround a solid dielectric block in use of the fabrication and wherein:
the step of heating the lucent material surrounding the other face end of the void to drive off volatile impurity from the excitable material is carried out by directing a high temperature gas flow into the cavity and against the tube forming the void at its sealed end via a piercing in the tubular wall.

25. A method according to claim 13, wherein the step of sealing of the void is performed by heating of the tube at or preferably adjacent the front or tubular wall, allowing differential pressure, normally atmospheric pressure, or more accurately the difference between ambient pressure and internal pressure, to collapse the tube and seal itself, preferably adjacent the said wall to leave a stub of tube extending from the wall with the void within the tube extending through the wall.
